(19) United States
(12) Patent Application Publication
(10) Pub. No.: US 2005/0220398 A1
(43) Pub. Date: Oct. 6, 2005

(54) Optical module

(75) Inventors: Makoto Shiraishi, Aichi (JP); Kentaro Hayashi, Aichi (JP); Yutaka Katsuyama, Osaka (JP)

Correspondence Address: OSHA LIANG L.L.P., 1221 MCKINNEY STREET, SUITE 2800, HOUSTON, TX, 77010, US

(73) Assignee: J.S.T. Mfg. Co., Ltd., Osaka (JP)

(21) Appl. No.: 11/091,039

(22) Filed: Mar. 28, 2005

(30) Foreign Application Priority Data
Mar. 30, 2004 (JP) JP2004-100091

(51) Int. Cl. G02B 6/28

(52) U.S. Cl. 385/24; 385/49

(57) ABSTRACT

An optical module has a plurality of filters that transmit or reflect lightwaves. First optical paths that guide a lightwave, second optical paths that guide only a lightwave having a specific wavelength, which passes through or is reflected by the filter, from the filter, third optical paths that guide a lightwave having a specific wavelength to the filter, and fourth optical paths that guide a lightwave from the filter are connected to the filters. The first to fourth optical paths are supported by optical path supporting members. A first optical fiber is connected to any one of the first optical paths. Second to fourth optical fibers are connected to the second to fourth optical paths, respectively, corresponding to the filter corresponding to the first optical path to which the first optical fiber is connected. Ends of the first to fourth optical fibers are supported by fiber supporting members. Each of the optical path supporting members is provided with a fitting portion to which the fiber supporting member is detachably attached.

### BACKGROUND OF THE INVENTION

1. Field of the Invention

The present invention relates to an optical module used in, for example, a system using a wavelength division multiplexing, and relates to an optical network system using this optical module.

2. Description of Related Art

Earnest development and research have been carried out concerning WDM (Wavelength Division Multiplexing) which is a broadband optical transmission technology and which is expected to be applied to, for example, backbone lines of the next generation Internet. In the WDM, high-capacity data can be transmitted by allowing light having different wavelengths to pass through a single optical fiber and by multiplexing a channel.

The optical network system employing the WDM uses an OADM (Optical Add/Drop Multiplexer) module in which only a lightwave having a specific wavelength is extracted or dropped from a plurality of lightwaves having mutually different wavelengths that are being transmitted through a single optical fiber or in which a lightwave having a specific wavelength is inserted or added into the optical fiber. With regard to the OADM module, a technique has been proposed for extracting only a lightwave having a specific wavelength from a plurality of lightwaves having mutually different wavelengths, or inserting a lightwave having a specific wavelength into an optical fiber by a combination of an optical waveguide and a wavelength selecting filter (see Japanese Published Unexamined Patent Application No. H11-109149). According to this technique, optical fibers are installed to extend through, for example, all floors of a building, and OADM modules connected to the optical fibers are disposed on the floors, and thereby it is possible to extract only a lightwave having an allocated wavelength from a plurality of lightwaves having mutually different wavelengths that are being transmitted through the optical fibers on the floors, or insert the lightwave having this wavelength into the optical fibers. The OADM modules are further connected to LANs (Local Area Network) constructed on the floors so as to enable data communications between the LANs, thus making it possible to easily establish a network covering the building.

In this case, data communications between the LANs are performed through the optical fibers. Therefore, when data is sent to a terminal that belongs to another LAN, a wavelength allocated to an OADM module connected to the LAN to which the terminal of a destination belongs is specified, transmission data is then converted into an optical signal formed of a lightwave having the specified wavelength, and is output to the optical fiber. The wavelength is specified based on a database that stores the relationship between, for example, a network address allocated to a terminal and a wavelength allocated to an OADM module connected to a LAN to which this terminal belongs. However, if the LANs are moved between the floors or if the wavelength allocated to the OADM module is changed, the relationship between the network address allocated to the terminal and the wavelength allocated to the OADM module connected to the LAN to which this terminal belongs will become different from that stored in the database, and data cannot be transmitted normally. This forces troublesome operations, such as updating the database or moving the OADM module together with the LAN.

### SUMMARY OF THE INVENTION

A main object of the present invention is to provide an optical module capable of easily changing the wavelength of a lightwave to be extracted from a plurality of lightwaves having mutually different wavelengths that are being transmitted through an optical fiber and the wavelength of a lightwave to be inserted into the optical fiber, and is to provide an optical network system using this optical module.

According to the first aspect of the invention, an optical module that has a plurality of filters that transmit or reflect lightwave is provided. The optical module has a plurality of first optical paths that correspond to the filters and that guide the lightwave to the filter, a plurality of second optical paths that correspond to the filters and that guide only the lightwave having a specific wavelength from the filters, a plurality of third optical paths that correspond to the filters and that guide the lightwave specific wavelength to the filter, a plurality of fourth optical paths that correspond to the filters and guide lightwave from the filters, and a plurality of optical path supporting members that support the first to fourth optical paths. Additionally, the optical module has a first optical fiber that is connected to any one of the first optical paths, a second filter that is connected to the second optical path corresponding to the first optical fiber, a third optical fiber that is connected to the third optical path corresponding to the first optical fiber, a fourth optical fiber that is connected to the fourth optical path corresponding to the first optical fiber, and a plurality of fiber supporting members that support the first to fourth optical fiber the optical path supporting members are provided with fitting portion to which the fiber supporting member are detachably attached.

According to the present invention, the wavelength of a lightwave to be extracted from a plurality of lightwaves having mutually different wavelengths that are being transmitted through a first optical fiber and the wavelength of a lightwave to be inserted into a fourth optical fiber can be changed by employing an easy method in which a fiber supporting member is attached to another fitting portion. Therefore, it is possible to cope with a change in the structure of a network by changing a wavelength allocated to an optical module.

### BRIEF DESCRIPTION OF THE DRAWINGS

Other and further objects, features and advantages of the invention will appear more fully from the following description taken in connection with the accompanying drawings in which:

FIG. 1 shows one example of a system structure of an optical network system according to a first embodiment of the present invention;

FIG. 2 is a block diagram showing an internal structure of a controller of FIG. 1;

FIG. 3 is a block diagram showing an internal structure of a node unit of FIG. 1;

FIG. 4 is a perspective view of an upper optical path supporter and a lower optical path supporter shown in FIG. 3 when viewed from their sides;

FIG. 5 is a perspective view of the upper optical path supporter and the lower optical path supporter shown in FIG. 3 when viewed from their opposite sides;

FIG. 6 is a perspective view of an upper fiber supporter and a lower fiber supporter shown in FIG. 3 when viewed from their sides;

FIG. 7 is a perspective view of the upper fiber supporter and the lower fiber supporter shown in FIG. 3 when viewed from their opposite sides;

FIG. 8 is a perspective view showing a state in which the upper and lower optical path supporters shown in FIG. 3 are not connected to the upper and lower fiber supporters shown in FIG. 3;

FIG. 9 is a perspective view showing a state in which the upper and lower optical path supporters shown in FIG. 3 have been connected to the upper and lower fiber supporters shown in FIG. 3;

FIG. 10 is an enlarged view of an optical waveguide of an OADM module shown in FIG. 3;

FIG. 11 is a block diagram showing an internal structure that is a modification of the node unit of FIG. 1; and

FIG. 12 is a block diagram showing an internal structure of the node unit according to a second embodiment of the present invention.

### DESCRIPTION OF THE PREFERRED EMBODIMENTS

A first embodiment of the present invention will be hereinafter described with reference to the attached drawings.

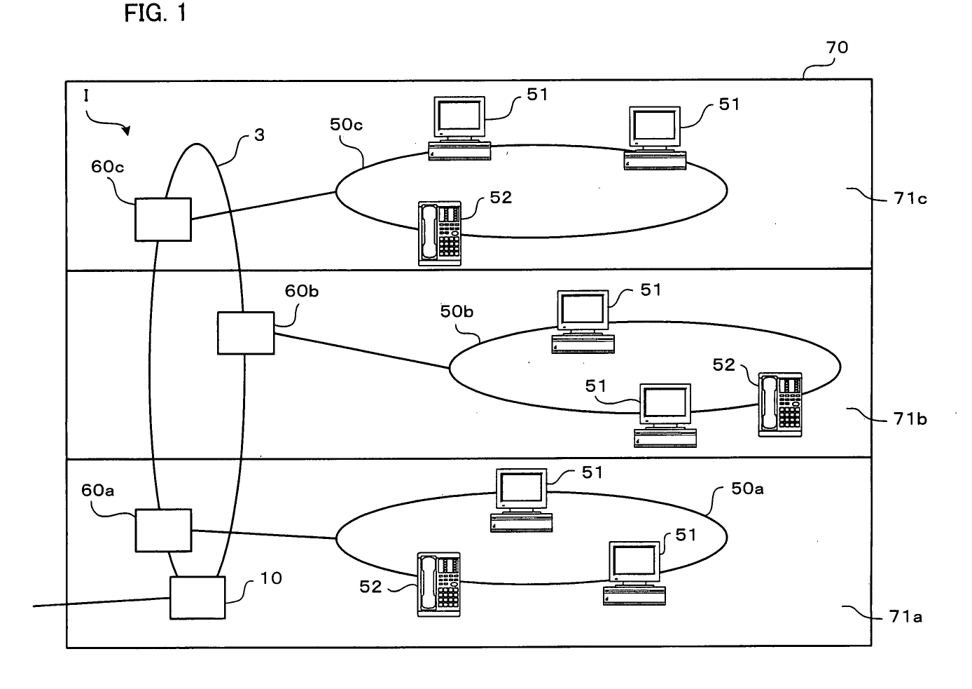

FIG. 1 is a view showing an example of a system structure of an optical network system 1 according to the first embodiment of the present invention. As shown in FIG. 1, the optical network system 1 is a network established in a building 70. The optical network system 1 includes a controller 10 connected to an outside network such as public lines, an optical fiber 3 connected to the controller 10, node units 60a to 60c connected to the optical fiber 3, and LANs 50a to 50c connected to the node units 60a to 60c, respectively.

The building 70 is a three-story building that has floors 71a to 71c. The optical fiber 3 is shaped like a ring and is disposed to pass through the floors 71a to 71c in the building 70. The node unit 60a and the LAN 50a connected to this node unit 60a are disposed on the floor 71a, the node unit 60b and the LAN 50b connected to this node unit 60b are disposed on the floor 71b, and the node unit 60c and the LAN 50c connected to this node unit 60 cared is posed on the floor 71c. A PC terminal 51, an IP telephone terminal 52, etc., are connected to each of the LANs 50a to 50c. These terminals maybe connected through a LAN cable, or may be connected through an optical fiber, or may be connected by radio.

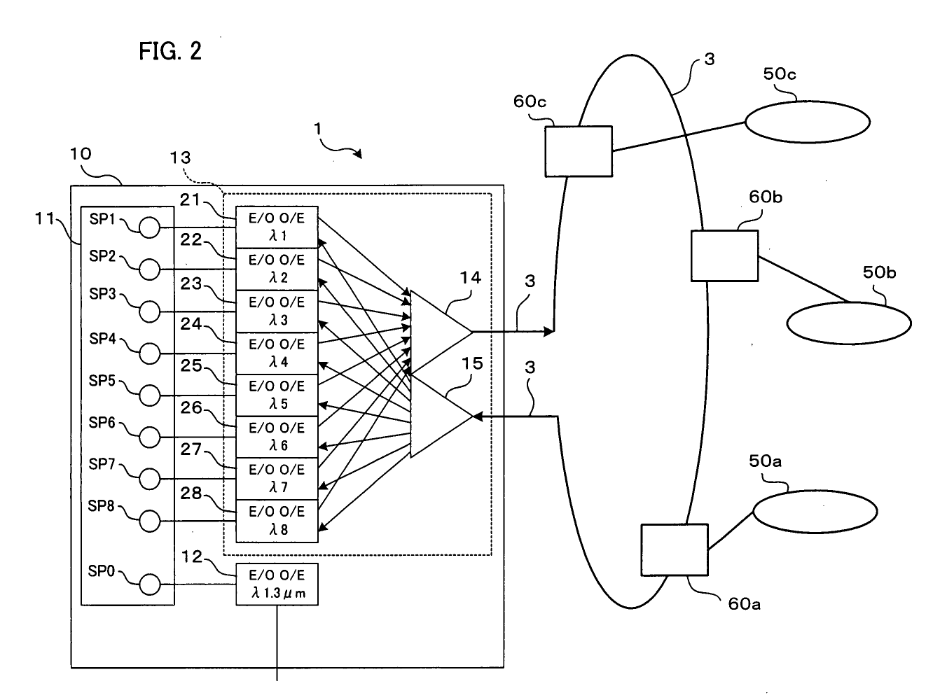

Next, the structure of the controller 10 will be described with reference to FIG. 2. FIG. 2 is a block diagram showing an internal structure of the controller 10. Arrows in the figure indicate directions in which an optical signal is transmitted. The controller 10 includes a “Layer 3 Switch” that is an electrical switch (hereinafter, referred to as “L3SW”) 11, an external converter 12 connected to a port SP0 of the L3SW 11, and a multiplex module (hereinafter, referred to as “MPX module”) 13 connected to ports SP1 to SP8 of the L3SW 11.

The L3SW 11 is a known switch used in, for example, a LAN (Local Area Network), and is a device used to perform third layer level switching of a seven-layer model of OSI (Open Systems Interconnection). The L3SW 11 outputs data from a port corresponding to a destination address included in data input to each port of the L3SW 11 based on the destination address included therein, and performs switching between subnetworks. A widely-used IP address can be conceived as the destination address. The subnetwork may be a known concept in which IP addresses are divided with a mask and are grouped according to an IP address value, or may be an IP address group that specifies a specific IP address value. The L3SW 11 has a switching function to perform switching with respect to IP addresses of the subnetwork. For example, the L3SW 11 can specify virtual LANs and perform switching between the virtual LANs. A method can be employed for routing between the subnetworks by means of a known router instead of the L3SW 11. Alternatively, a second layer switch can be used if the scale is small.

The external converter 12 converts an optical signal having a wavelength of, for example, 1.3 (μm) that is input from the outside of the optical network system 1 into an electric signal, and outputs the electric signal to the port SP0 of the L3SW 11. The external converter 12 further converts the electric signal output from the port SP0 of the L3SW 11 into an optical signal having a wavelength of, for example, 1.3 (μm), and outputs the optical signal outward.

The MPX module 13 includes converters 21 to 28 respectively connected to the ports SP1 to SP8 of the L3SW 11, an optical combining device 14, and an optical branching device 15. The converters 21 to 28 convert electric signals input from the ports SP1 to SP8 of the L3SW 11 connected thereto into optical signals having wavelengths of λ1 to λ8, respectively, corresponding thereto, and output the optical signals to the optical combining device 14. The converters 21 to 28 convert the optical signals having wavelengths of λ1 to λ8 output from the optical branching device 15 into electric signals, and output the electric signals to the ports SP1 to SP8, respectively, of the L3SW 11 connected thereto. The wavelengths λ1 to λ8 differ from each other, and belong to, for example, a waveband of 1.5 (μm). Especially, it is preferable to select wavelengths that are researched as CWDM (Coarse Wavelength-Division Multiplexing). For example, it is possible to use eight wavelengths, i.e., 1.47 (μm), 1.49 (μm), 1.51 (μm), 1.53 (μm), 1.55 (μm), 1.57 (μm), 1.59 (μm), and 1.61 (μm).

The optical combining device 14 combines together the optical signals having wavelengths of λ1 to λ8 output from the converters 21 to 28, and outputs a combined signal to the optical fiber 3. The optical branching device 15 branches an optical signal output from the optical fiber 3 into optical signals having wavelengths λ1 to λ8, and outputs these signals to the converters 21 to 28 corresponding to the wavelengths, respectively. According to this structure, the controller 10 controls the wavelength division multiplexing transmission in the optical fiber 3.

The controller 10 described above allows the optical branching device 15 to branch a plurality of lightwaves that have been output from the node units 60a to 60c and been propagated through the optical fiber 3 into lightwaves having their respective wavelengths. Branched lightwaves are converted into electric signals by means of the converters 21 to 28, and are output to the L3SW 11. Alternatively, lightwaves received from an outside network are converted into electric signals by means of the external converter 12, and are output to the L3SW 11. Based on destination information included in the received electric signals, the L3SW 11 converts the electric signals into lightwaves having wavelengths allocated to destinations, and outputs these to the optical fiber 3 or to the outside network. The node units 60a to 60c, which are the destinations, extract lightwaves having these wavelengths from the lightwaves propagated through the optical fiber 3 as described later.

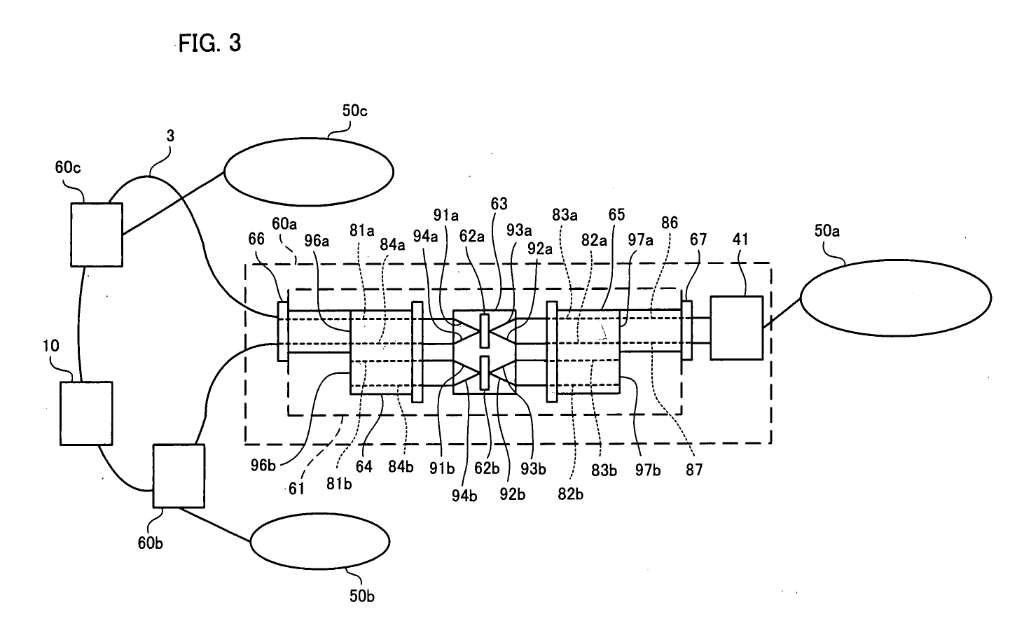

Next, the structure of the node units 60a to 60c will be described with reference to FIG. 3. Since each of the node units 60a to 60c has the same basic structure, only the node unit 60a will be described. FIG. 3 is a block diagram showing an internal structure of the node unit 60a. The node unit 60a is to extract a lightwave having a pre-allocated wavelength from the lightwaves propagated through the optical fiber 3 and to insert the lightwave having this wavelength into the optical fiber. The node unit 60a includes an OADM module 61 inserted in a halfway point of the optical fiber 3 and a converter 41 for LANs connected to this module.

The OADM module 61 extracts only the optical signal of a lightwave having a pre-allocated wavelength (e.g., λ1) from the optical signals of lightwaves having wavelengths of λ1 to λ8 transmitted through the optical fiber 3 so as not to overlap with another OADM module 61, and inserts the optical signal of a lightwave having this wavelength to the optical fiber 3. As described later, the OADM module 61 can selectively allocate mutually different_wavelengths λ1 and λ2. The two wavelengths can be freely selected from the eight wavelengths λ1 to λ8.

The structure of the OADM module 61 will now be described. The OADM module 61 includes a filter 62a that transmits only a lightwave having a wavelength of, for example, λ1 and a filter 62b that transmits only a lightwave having a wavelength of, for example, λ2. The filters 62a and 62b are dielectric multilayer film filters each of which is shaped like a rectangle and in each of which a plurality of dielectric films are superposed on a substrate. A lightwave of a specific wavelength that passes through the filter scan be adjusted by appropriately selecting the dielectric films. Devices other than the dielectric multilayer film filters can be used as the filters 62a and 62b.

The OADM module 61 additionally includes an optical waveguide 63 supporting the filters 62a and 62b. The optical waveguide 63 is disposed between an upper optical path supporter 64 and a lower optical path supporter 65, and includes a cladding layer formed on a substrate shaped like a substantially rectangular parallelepiped. The cladding layer can be made of an inorganic material such as quartz or can be made of an organic material such as plastic. The filters 62a and 62b are glued to the cladding layer. The cladding layer includes optical paths 91a and 94a that extend over the filter 62a from its side facing the upper optical path supporter 64, optical paths 92a and 93a that extend over the filter 62a from its side facing the lower optical path supporter 65, optical paths 91b and 94b that extend over the filter 62b from its side facing the upper optical path supporter 64, and optical paths 92b and 93b that extend over the filter 62b from its side facing the lower optical path supporter 65. These optical paths 91a to 94a and 91b to 94b can be formed according to a known technique for forming an area having a slightly heightened refractive index in the cladding layer.

The OADM module 61 additionally includes optical fibers 81a and 81b connected to the optical paths 91a and 91b, respectively, of the optical waveguide 63, optical fibers 82a and 82b connected to the optical paths 92a and 92b, respectively, optical fibers 83a and 83b connected to the optical paths 93a and 93b, respectively, and optical fibers 84a and 84b connected to the optical paths 94a and 94b, respectively. In this embodiment, an optical path consisting of the optical path 91a and the optical fiber 81a, and an optical path consisting of the optical path 91b and the optical fiber 81b are each a first optical path according to the present invention, an optical path consisting of the optical path 92a and the optical fiber 82a, and an optical path consisting of the optical path 92b and the optical fiber 82b are each a second optical path according to the present invention, an optical path consisting of the optical path 93a, and the optical fiber 83a and an optical path consisting of the optical path 93b and the optical fiber 83b are each a third optical path according to the present invention, and an optical path consisting of the optical path 94a and the optical fiber 84a, and an optical path consisting of the optical path 94b and the optical fiber 84b are each a fourth optical path according to the present invention.

The OADM module 61 further includes an upper optical path supporter 64 supporting the ends of the optical fibers 81a, 84a, 81b, and 84b and a lower optical path supporter 65 supporting the ends of the optical fibers 82a, 83a, 82b, and 83b. Each of the upper optical path supporter 64 and the lower optical path supporter 65 is structured by integrally uniting four optical path supporting members according to the present invention together.

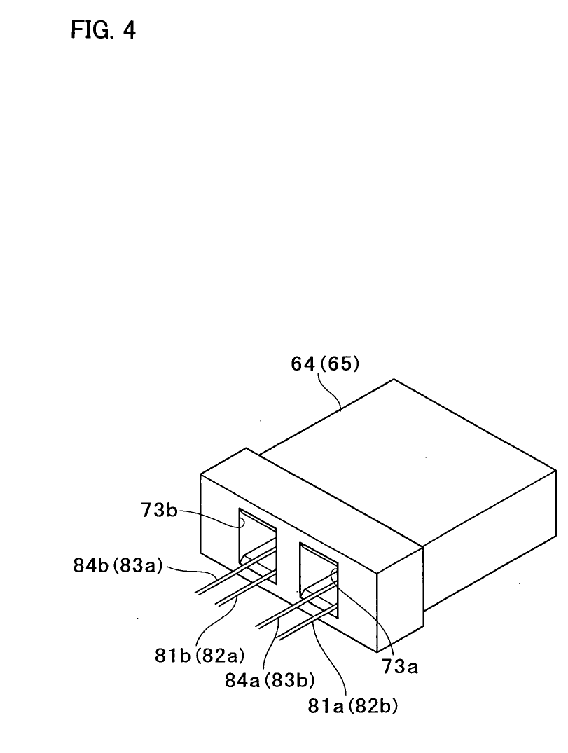

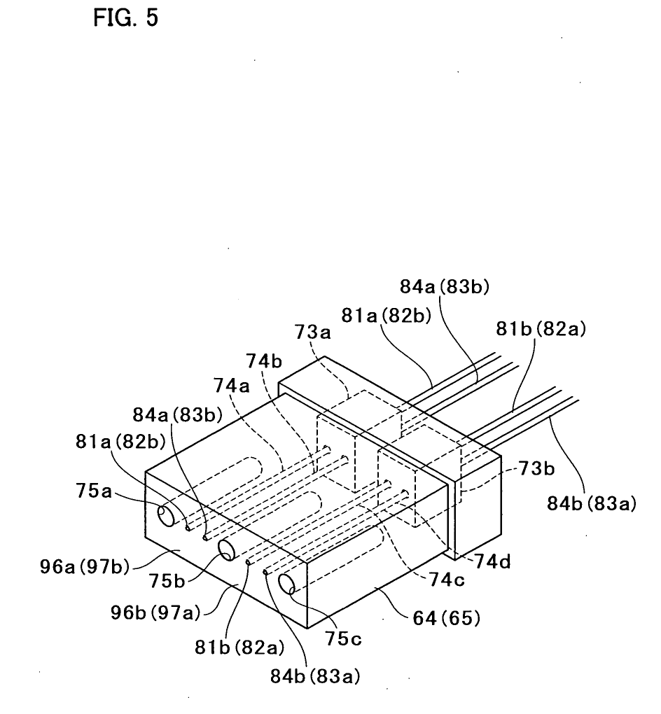

Referring now to FIG. 4 and FIG. 5, the upper optical path supporter 64 and the lower optical path supporter 65′ will be described. FIG. 4 is a perspective view of the upper optical path supporter 64 and the lower optical path supporter 65 when viewed from their sides. FIG. 5 is a perspective view of the upper optical path supporter 64 and the lower optical path supporter 65 when viewed from their opposite sides. In these figures, the reference character of the lower optical path supporter 65 is parenthesized. The upper optical path supporter 64 is a ferrule made of PPS (Polyphenylene-Sulfide) or LCP (Liquid Crystal Polymer), and, as shown in FIG. 4 and FIG. 5, is shaped like a substantially rectangular parallelepiped that has a brim at its end. The upper optical path supporter 64 has two holes 73a and 73b formed in its side face (hereinafter, referred to as “backface”) on the side of the brim, four holes 74a to 74b formed in its side face (hereinafter, referred to “front face”) on the opposite side of the brim, and three pin guides 75a to 75c that are holes formed in the front face.

The holes 73a and 73b used to insert the optical fibers 81a, 84a, 81b, and 84b are each shaped like a rectangular cylinder, and are arranged in the longitudinal direction of the backface of the upper optical path supporter 64. The optical fibers 81a and 84a are inserted into the hole 73a, and the optical fibers 81b and 84b are inserted into the hole 73b.

The holes 74a to 74d used to support the ends of the optical fibers 81a, 84a, 81b, and 84b inserted from the holes 73a and 73b are each shaped like a circular cylinder that passes through the bottoms of the holes 73a and 73b from the front face, and are arranged in the longitudinal direction of the front face of the upper optical path supporter 64. The holes 74a and 74b pass through the bottom of the hole 73a, and the holes 74c and 74d pass through the bottom of the hole 73b. In other words, the hole 74a supports the end of the optical fiber 81a, the hole 74b supports the end of the optical fiber 84a, the hole 74c supports the end of the optical fiber 81b, and the hole 74d supports the end of the optical fiber 84b. At this time, the ends of the optical fibers 81a, 84a, 81b, and 84b are disposed on the front face of the upper optical path supporter 64. The front face of the upper optical path supporter 64 is ground to be convex centering on the ends of the optical fibers 81a, 84a, 81b, and 84b.

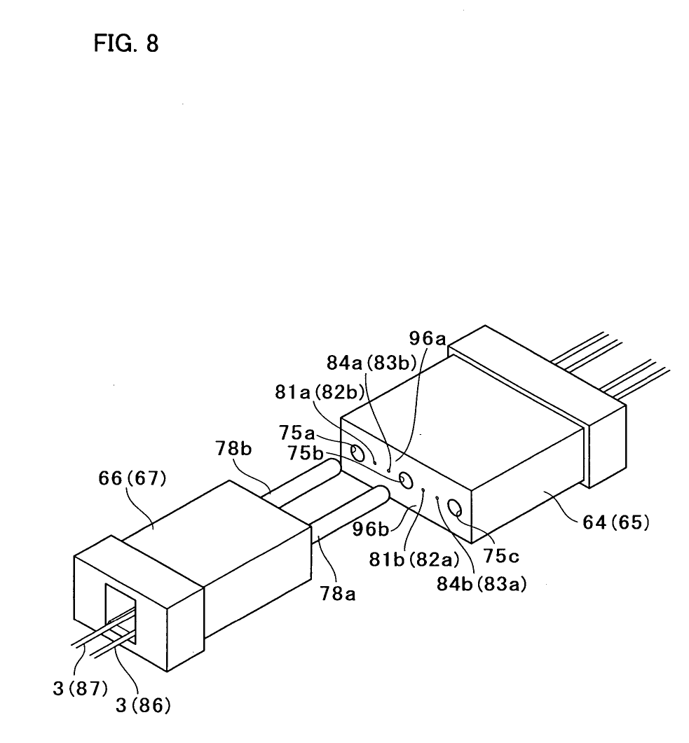

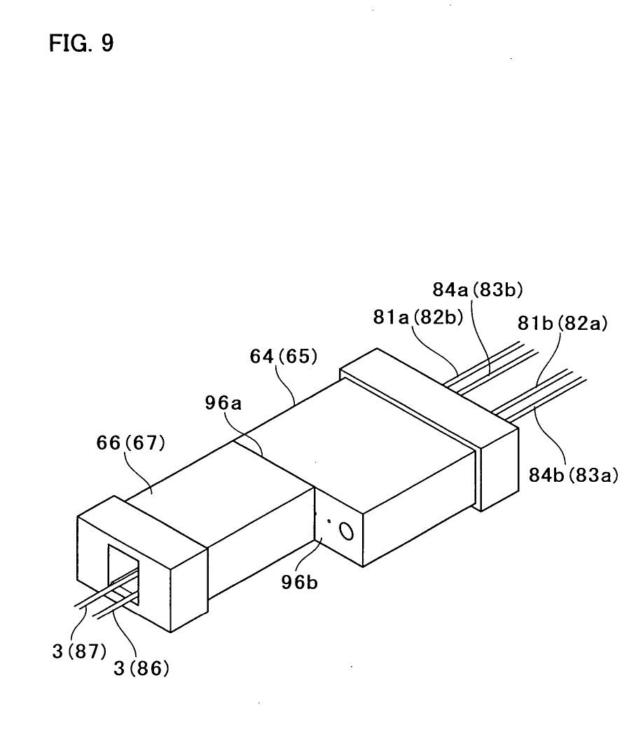

The pin guides 75a to 75c used to guide pins 78a and 78b included in the upper fiber supporter 66 described later (see FIG. 8 and FIG. 9) are each shaped like a circular cylinder, and are arranged together with the holes 74a to 74d in the longitudinal direction of the front face of the upper optical path supporter 64. The pin guides 75a and 75c are disposed at both sides of the holes 74a to 74d, and the pin guide 75c is disposed between the hole 74b and the hole 74c. In other words, the pin guides 75a and 75b are disposed at both sides of the holes 74a and 74b, and the pin guides 75b and 75c are disposed at both sides of the holes 74c and 74d. A fitting portion 96a is formed of the pin guides 75a and 75b, and a fitting portion 96b is formed of the pin guides 75b and 75c. The fitting portions 96a and 96b are used to attach or detach the upper fiber supporter 66. Thus, the distance in the longitudinal direction of the front face of the upper optical path supporter 64 is shortened by allowing the fitting portions 96a and 96b to share the pin guide 75b, and hence the OADM module 61 can be reduced in size.

The lower optical path supporter 65 is exactly the same in structure as the upper optical path supporter 64. The hole 74a supports the end of the optical fiber 82b, the hole 74b supports the end of the optical fiber 83b, the hole 74c supports the end of the optical fiber 82a, and the hole 74d supports the end of the optical fiber 83a. At this time, the ends of the optical fibers 82a, 83a, 82b, and 83b are disposed on the front face of the lower optical path supporter 65. The front face of the lower optical path supporter 65 is ground to be convex centering on the ends of the optical fibers 82a, 83a, 82b, and 83b. A fitting portion 97b is formed of the pin guides 75a and 75b, and a fitting portion 97a is formed of the pin guides 75b and 75c. The fitting portions 97a and 97b are used to attach or detach the upper fiber supporter 67 as described later.

The OADM module 61 includes the upper fiber supporter 66 and the lower fiber supporter 67. The upper fiber supporter 66 supports the end of the optical fiber 3, and can be attached to or detached from the fitting portions 96a and 96b, which are described later, of the upper optical path supporter 64. The lower fiber supporter 67 supports the end of a second optical fiber 87 connected to the converter 41 for LANs and the end of a third optical fiber 86, and can be attached to or detached from the fitting portions 97a and 97b, which are described later, of the lower optical path supporter 65. A part of the optical fiber 3 that is supported by the upper fiber supporter 66 and that is connected to the optical fiber 81a or 81b is a first optical fiber according to the present invention, and a part of the optical fiber 3 that is connected to the optical fiber 84a or 84b is a fourth optical fiber according to the present invention. In each of the upper fiber supporter 66 and the lower fiber supporter 67, two fiber supporting members according to the present invention are integrally formed.

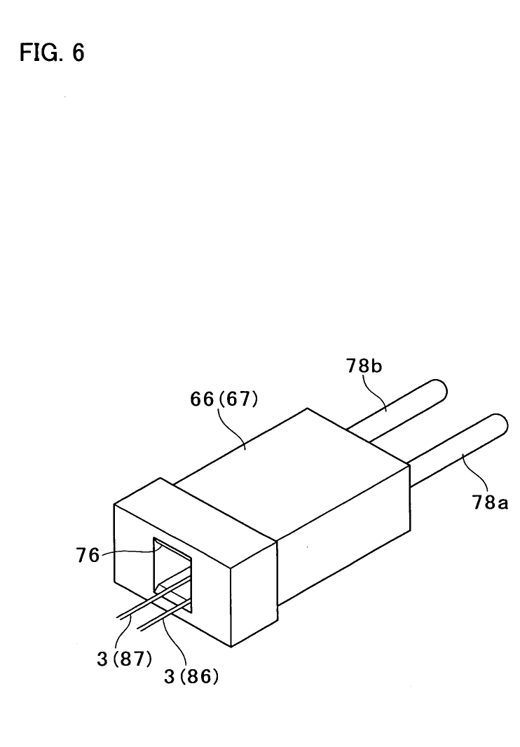

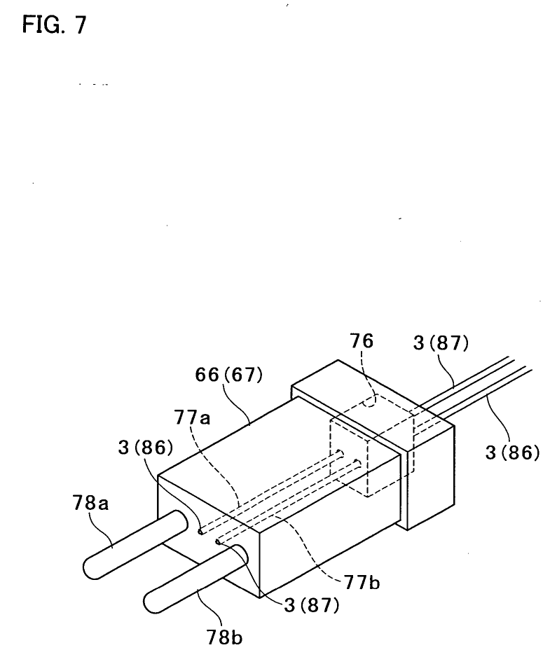

Referring now to FIG. 6 and FIG. 7, the upper fiber supporter 66 and the lower fiber supporter 67 will be described. FIG. 6 is a perspective view of the upper fiber supporter 66 and the lower fiber supporter 67 when viewed from their sides. FIG. 7 is a perspective view of the upper fiber supporter 66 and the lower fiber supporter 67 when viewed from their opposite sides. In these figures, the reference character of the lower fiber supporter 67 is parenthesized. The upper fiber supporter 66 is formed of a ferrule, and, as shown in FIG. 6 and FIG. 7, is shaped like a substantially rectangular parallelepiped that has a brim at its end. The upper fiber supporter 66 has a hole 76 formed in its side (hereinafter, referred to as “backface”) facing the brim, two holes 77a and 77b formed in its side (hereinafter, referred to “front face”) facing the opposite direction from the backface, and two pins 78a and 78b implanted into the front face.

The hole 76 is used to insert two optical fibers 3 (i.e., the first optical fiber and the fourth optical fiber) formed by cutting a part of a ring, and is shaped like a rectangular cylinder.

The holes 77a and 77b used to support the ends of the two optical fibers 3 inserted from the hole 76 are each shaped like a circular cylinder that passes through the bottom of the hole 76 from the front face, and are arranged in the longitudinal direction of the front face of the upper fiber supporter 66. When the holes 77a and 77b support the ends of the two optical fibers 3, the ends of the two optical fibers 3 are disposed on the front face of the upper fiber supporter 66. The front face of the upper fiber supporter 66 is ground to be convex centering on the end of the optical fiber 3.

The upper fiber supporter 66 can be selectively attached to either the fitting portion 96a or the fitting portion 96b of the upper optical path supporter 64. When the upper fiber supporter 66 is attached to the fitting portion 96a of the upper optical path supporter 64, the pins 78a and 78b are guided by the pin guides 75a and 75b of the upper optical path supporter 64, and, when the upper fiber supporter 66 is attached to the fitting portion 96b of the upper optical path supporter 64, the pins 78a and 78b are guided by the pin guides 75b and 75c of the upper optical path supporter 64. The pins 78a and 78b are arranged together with the holes 77a and 77b in the longitudinal direction of the front face of the upper fiber supporter 66. The pins 78a and 78c are disposed at both sides of the holes 77a and 77b.

The lower fiber supporter 67 is exactly the same in structure as the upper fiber supporter 66. The hole 77a supports the end of the optical fiber 86, and the hole 77b supports the end of the optical fiber 87. At this time, the ends of the optical fibers 86 and 87 are disposed on the front face of the lower fiber supporter 67. The front face of the lower fiber supporter 67 is ground to be convex centering on the ends of the optical fibers 86 and 87.

Referring back to FIG. 3, the converter 41 for LANs is a converter that has a light-to-electricity converter and an electricity-to-light converter. An optical signal output from the OADM module 61 through the second optical fiber 87 is converted into an electric signal, and is output to the LAN 50a. An electric signal input from the LAN 50a through the second optical fiber 87 is converted into an optical signal of a lightwave having a wavelength allocated to the OADM module 61, and is output to the OADM module 61.

The thus structured node units 60a to 60c can be connected to arbitrary points on the optical fiber 3, and can be increased in number up to the number of ports of the MPX module 13 of the controller 10.

Referring now to FIG. 8 and FIG. 9, a description will be given of a method for a connection between the upper and lower optical path supporters 64 and 65 and the upper and lower fiber supporters 66 and 67. FIG. 8 is a perspective view showing a state in which the upper and lower optical path supporters 64 and 65 are not connected to the upper and lower fiber supporters 66 and 67. FIG. 9 is a perspective view showing a state in which the upper and lower optical path supporters 64 and 65 have been connected to the upper and lower fiber supporters 66 and 67. In these figures, the reference character of the lower optical path supporter 65 and the reference character of the lower fiber supporter 67 are parenthesized. Since a method for a connection between the upper optical path supporter 64 and the upper fiber supporter 66 is the same as a method for a connection between the lower optical path supporter 65 and the lower fiber supporter 67, only the connection method of the upper optical path supporter 64 and the upper fiber supporter 66 will be described.

The upper fiber supporter 66 can be selectively attached to either the fitting portion 96a or the fitting portion 96b of the upper optical path supporter 64, and the lower fiber supporter 67 can be selectively attached to either the fitting portion 97a or the fitting portion 97b of the lower optical path supporter 65. When the upper fiber supporter 66 is attached to the fitting portion 96a, the upper fiber supporter 67 is attached to the fitting portion 97a. When the upper fiber supporter 66 is attached to the fitting portion 96b, the lower fiber supporter 67 is attached to the fitting portion 97b (see FIG. 3).

For example, when the upper fiber supporter 66 is attached to the fitting portion 96a of the upper optical path supporter 64, the front face of the upper supporter 66 is caused to face the front face of the lower optical path supporter 64 so that the pin 78b of the upper fiber supporter 66 can face the pin guide 75a of the upper optical path supporter 64 and so that the pin 78a can face the pin guide 75b as shown in FIG. 8. In this state, the upper fiber supporter 66 is pushed toward the upper optical path supporter 64. Accordingly, the pin 78b is inserted into the pin guide 75a, and the pin 78a is inserted into the pin guide 75b. The pin guides 75a and 75b accurately position the upper fiber supporter 66 while guiding the pins 78a and 78b inserted thereinto. The upper fiber supporter 66 is attached to the fitting portion 96a by bringing the front face of the upper fiber supporter 66 into close contact with the front face of the upper optical path supporter 64 as shown in FIG. 9.

When the upper fiber supporter 66 is attached to the fitting portion 96a in this way, an end face on which the end of the optical fiber 3 is disposed comes into contact with an end face of the fitting portion 97a, so that the end of the optical fiber 3 through which a lightwave is propagated is connected to the end of the optical fiber 81a, and the end of the optical fiber 3 through which a lightwave is propagated is connected to the end of the optical fiber 84a. When the lower fiber supporter 67 is attached to the fitting portion 97a, an end face on which the ends of the optical fibers 86 and 87 are disposed comes into contact with the end face of the fitting portion 97a, so that the end of the third optical fiber 86 is connected to the end of the optical fiber 83a, and the end of the second optical fiber 87 is connected to the end of the optical fiber 82a.

Likewise, the upper fiber supporter 66 is attached to the fitting portion 96b by inserting the pin 78b into the pin guide 75b and inserting the pin 78a into the pin guide 75c so as to bring the front face of the upper fiber supporter 66 into contact with the front face of the upper optical path supporter 64. Hereby, an end face on which the end of the optical fiber 3 is disposed comes into contact with an end face of the fitting portion 97b, so that the end of the optical fiber 3 through which a lightwave is propagated is connected to the end of the optical fiber 81b, and the end of the optical fiber 3 through which a lightwave is propagated is connected to the end of the optical fiber 84b. When the lower fiber supporter 67 is attached to the fitting portion 97b, an end face on which the ends of the optical fibers 86 and 87 are disposed comes into contact with the end face of the fitting portion 97b, so that the end of the optical fiber 86 is connected to the end of the optical fiber 83b, and the end of the optical fiber 87 is connected to the end of the optical fiber 82b.

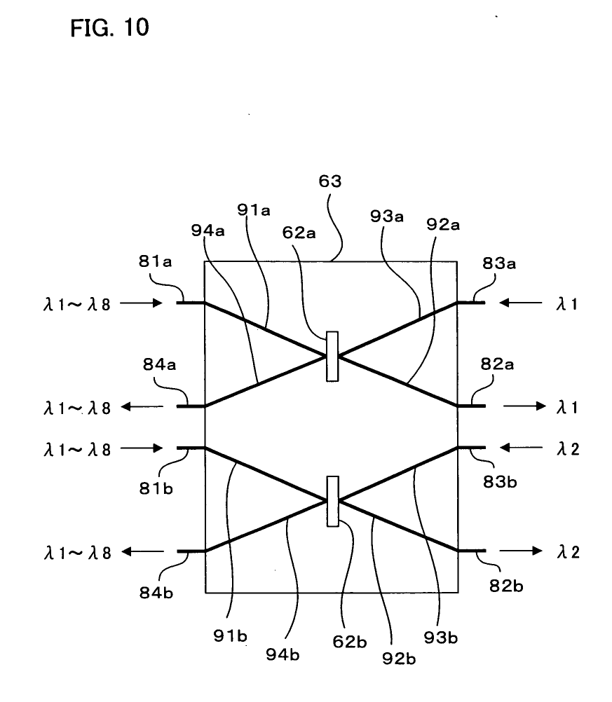

Next, the operation of the OADM module 61 will be described with reference to FIG. 3 and FIG. 10. FIG. 10 is an enlarged view of the optical waveguide 63 of the OADM module 61. When the upper fiber supporter 66 is attached to the fitting portion 96a, and when the lower fiber supporter 67 is attached to the fitting portion 97a, eight lightwaves having wavelengths of λ1 to λ8 transmitted through the optical fiber 3 are output to the optical path 91a through the optical fiber 81a connected to the optical fiber 3 (apart corresponding to the first optical fiber) as shown in FIG. 10. The eight lightwaves of wavelengths λ1 to λ8 output to the optical path 91a are propagated through the optical path 91a, and are guided to the filter 62a. The lightwave of wavelength λ1 among the eight lightwaves of wavelengths λ1 to λ8 that have been guided to the filter 62a passes through the filter 62a, and is output to the optical path 92a. The lightwave of wavelength λ1 that has been output to the optical path 92a is propagated through the optical path 92a, and is output to the optical fiber 82a. The lightwave of wavelength λ1 that has been output to the optical fiber 82a is output to the converter 41 for LANs through an optical fiber 62 connected to the fiber 82a. The lightwave of wavelength λ1 that has been output to the converter 41 for LANs is converted into an electric signal, and is transmitted to a terminal belonging to the LAN 50a.

The seven lightwaves of wavelengths λ2 to λ8 guided to the filter 62a are reflected by the filter 62a, and are output to the optical path 94a. The seven lightwaves of wavelengths λ2 to λ8 output to the optical path 94a are propagated through the optical path 94a, and are output to the optical fiber 84a. The seven lightwaves of wavelengths λ2 to λ8 output to the optical fiber 84a are output to the optical fiber 3 connected to the optical fiber 84a, and are propagated through the optical fiber 3.

An electric signal transmitted from the terminal belonging to the LAN 50a is transmitted to the converter 41 for LANs. The electric signal transmitted to the converter 41 for LANs is converted into a lightwave of wavelength λ1, and is output to the optical fiber 86. The lightwave of wavelength λ1 output to the optical fiber 86 is output to the optical path 93a through the optical fiber 83a connected to the optical fiber 86. The lightwave of wavelength λ1 output to the optical path 93a is propagated through the optical path 93a, and is guided to the filter 62a. The lightwave of wavelength λ1 guided to the filter 62a passes through the filter 62a, and is output to the optical path 94a. The lightwave of wavelength λ1 output to the optical path 94a is propagated through the optical path 94a, and is output to the optical fiber 84a. The lightwave of wavelength λ1 output to the optical fiber 84a is inserted into the seven lightwaves of wavelengths λ2 to λ8 reflected by the filter 62a. The eight lightwaves of wavelengths λ1 to λ8 are input to the optical fiber 3 connected to the optical fiber 84a, and are propagated through the optical fiber 3.

Thus, the OADM module 61, in which the upper fiber supporter 66 is attached to the fitting portion 96a and in which the lower fiber supporter 67 is attached to the fitting portion 97a, can extract only the lightwave of wavelength λ1 from the optical fiber 3 by use of the filter 62a, and can transmit the lightwave to the LAN 50a, so that wavelength λ1 sent from the LAN 50a can be inserted to the optical fiber 3.

Through substantially the same process as this one, the OADM module 61, in which the upper fiber supporter 66 is attached to the fitting portion 96b and in which the lower fiber supporter 67 is attached to the fitting portion 97b, can drop only the lightwave of wavelength 2 from the optical fiber 3 by use of the filter 62b, and can transmit this lightwave to the LAN 50a, so that wavelength 2 sent from the LAN 50a can be added to the optical fiber 3.

According to the first embodiment described above, the OADM module 61 can change the wavelength of a light wave extracted from a plurality of lightwaves that have mutually different wavelengths and that have been transmitted through the optical fiber 3 and can change the wavelength of a lightwave inserted into the optical fiber 3 according to an easy method in which the attached positions (the fitting portions 96a, 96b, 97a, 97b) of the upper fiber supporter 66 and the lower fiber supporter 67 are changed. Therefore, it is possible to easily cope with a change in the structure of the optical network system 1, such as the replacement of the LANs 50a to 50c with each other on the floors of the building 70.

Additionally, since the OADM module 61 includes the optical waveguide 63, the optical paths around the filters 62a and 62b can be produced with high accuracy. Additionally, the optical waveguide 63 can be separated from each of the optical path supporters 64 and 65 by using the optical fibers 81a to 84a and 81b to 84b. Therefore, the fitting-portions 96a, 96b, 97a, and 97b can be easily formed without processing the optical waveguide 63.

Additionally, since the optical path supporters 64 and 65 and the fiber supporters 66 and 67 are formed of ferrules, the optical fibers 81a to 84a and 81b to 84b can be butted and joined to the optical fibers 3, 86, and 87 with high accuracy. Additionally, the optical path supporters 64 and 65 and the fiber supporters 66 and 67 can be processed easily and freely.

Additionally, since the fiber supporters 66 and 67 have the pins 78a and 78b and since the optical path supporters 64 and 65 have the pin guides 75a to 75c used to guide these pins, the optical fibers 81a to 84a and 81b to 84b can be butted and joined to the optical fibers 3, 86, and 87 with high accuracy.

Additionally, since the upper optical path supporter 64 and the lower optical path supporter 65 are disposed to face each other with the filters 62a and 62b therebetween, the optical fiber 3 and the optical fibers 86 and 87 can be disposed along the flow of lightwaves with high efficiency.

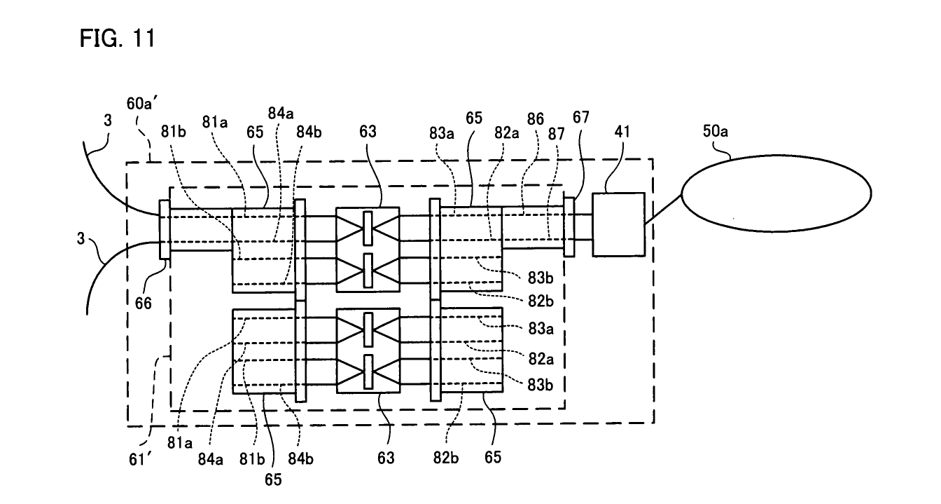

In the first embodiment described above, the OADM module 61 is structured so that one of two wavelengths can be selectively allocated to the node units 60a to 60c by providing the OADM module 61 with one optical waveguide 63, one optical path supporter 64, and one optical path supporter 65. However, without being limited to this structure, one of a great number of wavelengths may be selectively allocated to the node units. For example, as shown in FIG. 11, the OADM module 61′ may include two optical waveguides 63, two optical path supporters 64, and two optical path supporters 65. In this example, it is recommended to appropriately select and dispose four filters that transmit mutually different wavelengths. According to this structure, one of the four wavelengths can be selectively allocated to the node units. Therefore, if the optical network system 1 is changed in structure, it is possible to cope with this change more flexibly and easily.

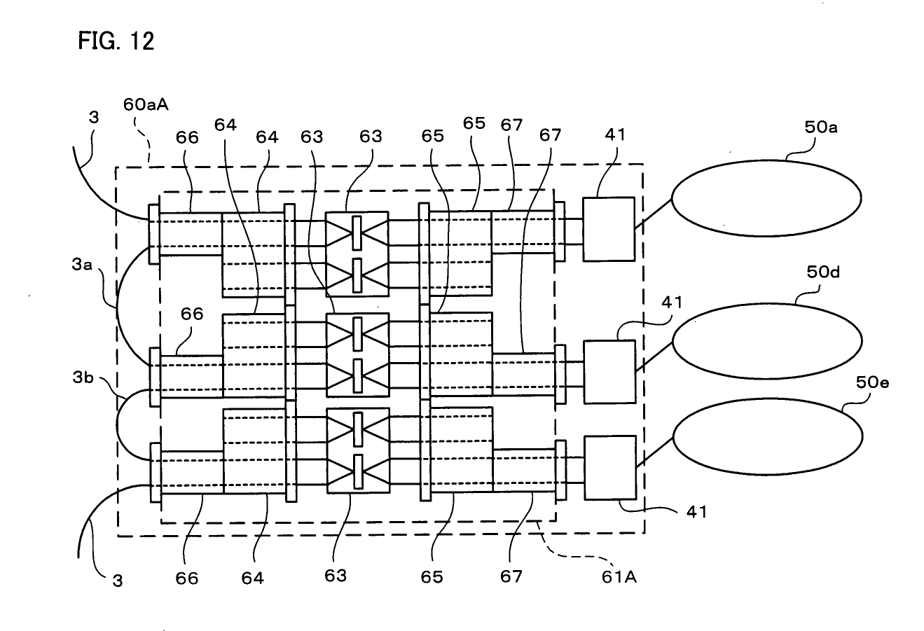

Next, a second embodiment of the present invention will be described with reference to FIG. 12. The second embodiment differs from the first embodiment only in the structure of the node unit corresponding to the node unit 60a of the first embodiment. Therefore, the same reference characters as in the first embodiment are given substantially the same members, respectively, other than this node unit, and a description thereof is omitted. FIG. 12 is a block diagram showing an internal structure of a node unit 60aA of the second embodiment. As shown in FIG. 12, the node unit 60aA is to extract and insert three lightwaves having mutually different wavelengths pre-allocated from lightwaves propagated through the optical fiber 3. The node unit 60aA includes an OADM module 61A inserted in a halfway point of the optical fiber 3 and three converters 41 for LANs connected to this module.

Since the OADM module 61A and the converters 41 for LANs are substantially the same in structure as in the first embodiment, a description thereof is omitted. One upper fiber supporter 66 supports an end of the optical fiber 3 by means of the hole 77b, and supports an end of the optical fiber 3a by means of the hole 77a (see FIG. 7). Another upper fiber supporter 66 supports an opposite end of the optical fiber 3a by means of the hole 77b, and supports an end of the optical fiber 3b by means of the hole 77a. The remaining upper fiber supporter 66 supports an opposite end of the optical fiber 3b by means of the hole 77b, and supports an end of the optical fiber 3 by means of the hole 77a. In other words, the three upper fiber supporters 66 are connected together in the form of a cascade by means of the optical fibers 3, 3a, and 3b.

According to the second embodiment described above, the three LANs 50a, 50d, and 50e, and other network devices can be arbitrarily connected to the single node unit 60aA. If such LANs or network devices are not connected thereto, it is recommended to detach the upper fiber supporter 66, which is not connected thereto, from the cascade connection. Accordingly, even when the optical network system 1 is changed in structure, it is possible to cope with this change more flexibly.

A modification of the two embodiments described above will be briefly described. In the first embodiment, the filters 62a and 62b that transmit lightwaves having specific wavelengths are used. However, without being limited to this, filters that reflect the lightwaves may be used by changing the optical paths therearound.

In the first embodiment, a part of the first to fourth optical paths is formed with the optical paths 91a to 94a and 91b to 94b of the optical waveguide 63. However, without being limited to this, all of the optical paths may be formed with only an optical fiber, for example.

In the first embodiment, the four optical fibers 81a, 84a, 81b, and 84b and the four optical fibers 82a, 83a, 82b, and 83b are supported by the single optical path supporter, but the present invention is not limited to this. For example, one optical fiber may be supported by one optical path supporter. Alternatively, some of these optical fibers may be supported by the single optical path supporter. For example, if a plurality of optical fibers are supported by one optical path supporter, great costs are necessary to exchange the optical path supporter with another when the optical path supporter is damaged, because the optical path supporter has a relatively large size. In contrast, if one optical fiber is supported by one optical path supporter, costs required to exchange the optical path supporter with another can be reduced when the optical path supporter is damaged, because the optical path supporter is small in size.

In the first embodiment, the two parts of the optical fiber 3 are supported by the single fiber supporter, and the two optical fibers 86 and 87 are supported by the single fiber supporter, but the present invention is not limited to this structure. For example, one optical fiber may be supported by one fiber supporter. Alternatively, some of these optical fibers may be supported by one fiber supporter. For example, if a plurality of optical fibers are supported by one fiber supporter, great costs are necessary to exchange the fiber supporter with another when the fiber supporter is damaged, because the fiber supporter has a relatively large size. In contrast, if one optical fiber is supported by one fiber supporter, costs required to exchange the fiber supporter with another can be reduced when the fiber supporter is damaged, because the fiber supporter is small in size.

In the first embodiment, the optical waveguide 63 is separated from the optical path supporters 64 and 65. However, without being limited to this structure, the fiber supporters may be provided directly on the optical waveguide 63.

In the first embodiment, the optical path supporters 64 and 65 and the fiber supporters 66 and 67 are formed of ferrules. However, these supporters may be formed of other materials excellent in durability and in cost.

In the first embodiment, the optical path supporters 64 and 65 include the pin guides 75a to 75c, and the fiber supporters 66 and 67 include the pins 78a and 78b, but the present invention is not limited to this structure. For example, each optical path supporter may include pins, and each fiber supporter may include pin guides. Alternatively, these supporters may include neither pin nor pin guide.

In the first embodiment, the optical path supporters are separated into the upper one and the lower one, and are disposed to face each other with the filters 62a and 62b therebetween, but the present invention is not limited to this structure. For example, the optical path supporters may be disposed to be adjacent to each other, or may be formed integrally with each other without being separated into the upper and lower ones.

In the first embodiment, the attached positions of the fiber supporters are manually changed. Instead, the fiber supporters may be moved by an actuator so as to change their attached positions. For example, a piezoelectric element can be used as the actuator. When the attached positions of the fiber supporters are changed by the actuator, it is preferable to control these together by use of a controller. Thereby, a wavelength allocated to each node unit can be changed freely and automatically.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. An optical module comprising:
a plurality of filters that transmit or reflect lightwaves;
a plurality of first optical paths that correspond to the filters, respectively, and that guide the lightwaves to the filters;
a plurality of second optical paths that correspond to the filters, respectively, and that guide only the lightwave having a specific wavelength from the filters, the lightwave passing through or being reflected by the filters;
a plurality of third optical paths that correspond to the filters, respectively, and that guide the lightwave having the specific wavelength to the filters;
a plurality of fourth optical paths that correspond to the filters, respectively, and that guide a plurality of lightwaves having a wavelength or having mutually different wavelengths from the filters, the lightwaves passing through or being reflected by the filters;
a plurality of optical path supporting members that support the first to fourth optical paths;
a first optical fiber connected to any one of the first optical paths;
a second optical fiber connected to the second optical path corresponding to the filter corresponding to the first optical path to which the first optical fiber is connected;
a third optical fiber connected to the third optical path corresponding to the filter corresponding to the first optical path to which the first optical fiber is connected;
a fourth optical fiber connected to the fourth optical path corresponding to the filter corresponding to the first optical path to which the first optical fiber is connected; and
a plurality of fiber supporting members that support ends of the first to fourth optical fibers;
wherein the plurality of optical path supporting members are provided with fitting portions to which the fiber supporting members are detachably attached.

2. The optical module according to claim 1, wherein at least a part of the first to fourth optical paths is formed of an optical waveguide.

3. The optical module according to claim 2, wherein the first to fourth optical paths are formed of the optical waveguides and a plurality of optical fibers connected to the optical waveguides, and the optical path supporting members support ends of the optical fibers.

4. The optical module according to claim 1, wherein the optical path supporting members and the fiber supporting members are formed of ferrules.

5. The optical module according to claim 1, wherein either the fiber supporting members or the fitting portions of the optical path supporting members have a positioning pin, and the other has a positioning guide at a position corresponding to the positioning pin.

6. The optical module according to claim 1, wherein the first optical fiber is one in number, the second optical fiber is one in number, the third optical fiber is one in number, and the fourth optical fiber is one in number.

7. The optical module according to claim 1, wherein the first optical fiber is plural in number, the second optical fiber is plural in number, the third optical fiber is plural in number, and the fourth optical fiber is plural in number, the first to fourth optical fibers being equal in number.

8. The optical module according to claim 1, further comprising:
one or more upper optical path supporters in which the optical path supporting members supporting the first optical paths corresponding to the filters, respectively, and the optical path supporting members supporting the fourth optical paths are formed;
one or more lower optical path supporters in which the optical path supporting members supporting the second optical paths corresponding to the filters, respectively, and the optical path supporting members supporting the third optical paths are formed;
an upper fiber supporter in which the fiber supporting member supporting the first optical fiber and the fiber supporting member supporting the fourth optical fiber are formed; and
a plurality of lower fiber supporters in which the fiber supporting member supporting the second optical fiber and the fiber supporting member supporting the third optical fiber are formed.

9. The optical module according to claim 8, wherein the upper optical path supporters and the lower optical path supporters are disposed to face each other with the filters corresponding thereto between the upper optical path supporters and the lower optical path supporters.

10. A plurality of optical modules comprising:
a plurality of the optical modules according to claim 1 that the optical modules being connected together in cascade form, wherein the fourth optical fiber of the optical module that is a preceding one is connected to the first optical fiber of the optical module that is a following one in a direction in which the lightwave travels.

11. An optical network system comprising:
a ring-shaped network optical fiber that transmits a plurality of lightwaves having mutually different wavelengths;
a controller connected to the network optical fiber; and
the optical modules of claim 1 to which mutually different wavelengths are allocated, the optical modules being connected to the network optical fiber;
wherein the controller converts a lightwave received from the optical modules through the network optical fiber into an electric signal,
the controller specifies a destination from destination information contained in the electric signal,
the controller converts the electric signal into a lightwave having a wavelength allocated for each of the optical modules to which the lightwave is transmitted and then outputs the lightwave to the network optical fiber, and
the optical module has a structure in which the network optical fiber is supported by the fiber supporting member, the fiber supporting member is attached to the fitting portion of the optical path supporting member corresponding to the filter that transmits or reflects the lightwave having the allocated wavelength, the lightwave having this wavelength is extracted from the lightwaves input to the first optical path from the network optical fiber, and the lightwave having this wavelength is output from the fourth optical path to the network optical fiber.
